(19) United States
(12) Patent Application Publication
(10) Pub. No.: US 2022/0340387 A1
(43) Pub. Date: Oct. 27, 2022

(54) Marking system for rolled materials having transparency or translucence to pinpoint a tear

(71) Applicant: Robert Alan Bard, Brielle, NJ (US)

(72) Inventor: Robert Alan Bard, Brielle, NJ (US)

(21) Appl. No.: 17/300,880

(22) Filed: Dec. 6, 2021

Related U.S. Application Data
(60) Provisional application No. 63/258,334, filed on Apr. 24, 2021.

(51) Int. Cl. B65H 23/038; G09F 3/02

(52) U.S. Cl. CPC B65H 23/038; G09F 3/02; G09F 2003/0269

(57) ABSTRACT

A marking system on the full length of rolled material to pinpoint the location of a tear in the rolled material by either incorporating or adding an opaque portion/strip having a “telltale” marking such as a line along the full length of the rolled material such that the line will experience a visible break along the tear line when the rolled material is torn.

### PRIOR PUBLICATION DATA

Provisional Patent Application No. 63/258,334 Filing Date: Apr. 24, 2021 patent application Ser. No. 17/300,557 Filing Date: Aug. 16, 2021

### FIELD OF INVENTION

A marking system for rolled materials that presents as partially either transparent or translucent—because said rolled materials also contain a full length marking such as a “telltale” line included on and also within the width of the full length opaque colored portion/strip which in turn is both fully contained on said rolled material and therefore of lessor width than the width of said rolled material such that the marking system distinguishes/pinpoints the location of each actual tear after a portion of said rolled material has been removed/torn from said rolled material's roll thus saving personal frustration, wasted material and wasted time.

### BACKGROUND OF THE INVENTION

People have become frustrated and have wasted much material and much time trying to find the exact location of the actual tear on said rolled material being that the location of the actual tear is also the actual starting point/location for the removal of the rolled material that is left on the roll of said rolled material after a portion of said rolled material has been removed from the roll of said rolled material.

### BRIEF DESCRIPTION OF THE DRAWINGS

FIG. 1 and FIG. 2 both deal with the invention when the invention is paired with said rolled materials that are purposely shown in FIGS. 1 and 2 as being in the partially either transparent or translucent (herein after P*E*TP*O*TL) state because the rolled material also contains an opaque fixed width portion that is both fully contained at a fixed position within and parallel to the outer side edges of said portion of said rolled material as well as having one side of said opaque fixed width portion being adjacent to said P*E*TP*O*TL portion of said rolled material in addition to being coincident with one of the side edges of said portion of said rolled material such that, in addition, said opaque fixed width portion of said rolled material has been especially designed to also contain a marking such as a “telltale” line showing differently from said opaque fixed width portion of said portion of said rolled material and very strategically and methodically placed/located for the purpose of locating the actual tear of said rolled material following each and every removal of said rolled material from the roll of said rolled material. At this stage of the brief description of the drawings it should be noted that, in actuality, said opaque fixed width portion of said rolled material, can be shown in any color without there being any limitation, however, because of the limitation of the drawings herein only being in black and white, said opaque fixed width portion of said rolled material needed to be shown as being crosshatched. FIG. 1 shows an example of the invention's varied applicability by showing the invention's applicability to a roll of tape where said roll of tape is partially unraveled to best show on the upper surface of said tape both the crosshatched opaque portion of said tape as well as, in this case, said solid black “telltale” line on said crosshatched opaque portion of said tape in order to differentiate said “telltale” line from said crosshatched opaque portion of said tape. Again, it is extremely important to be sure to recognize that as opposed to the afore mentioned black and white limitation, said opaque portion of said tape having a different color than said “telltale” line would suffice. In all cases said “telltale” line is purposely designed to continue to vary in distance interior to and from each/either side edge of said opaque portion of said tape and, for example and simplification purposes only, is again shown only as said single line in all figures. Also, for graphic purposes only, said “telltale” line is shown to be wider than all other lines in in FIG. 1 in order to differentiate said “telltale” line from all other lines in FIG. 1 because said “telltale” line is at the heart of this invention. It should also be noted that in FIG. 1 the unraveled portion of said tape is also shown as still being attached to said roll of said tape remaining on said roll of tape. The very end of the unraveled portion of said tape is the location where an actual separation of said tape occurred after the most previous/recent portion of said tape was torn off/removed from said roll of said tape. FIG. 2 shows the same said roll of said tape shown in FIG. 1, however, the unraveled portion of said tape is now re-attached to said roll of said tape and because of the effect of the continuous varying of the position of said “telltale” line relative to the side edges of said opaque portion of said tape FIG. 2 also shows both the location of an actual break in said “telltale” line which is the exact location of one point along the actual tear line of said tape, in other words, also being one point along the actual tear line of said tape that is left on said roll of tape after the most previous/recent portion of said tape that was torn off/removed from said roll of said tape as well as, at the same time, creating the optical illusion of what visually appears to be a break point on a second “telltale” line showing, however, is in fact, part of the one and only said “telltale” line leading to the creation of the following: a dotted line connecting the two afore mentioned break points whose sole purpose via said dotted line being dotted is to be differentiated from all other lines shown in FIG. 2 in order to help bring attention via the two end points of the dotted line to the the location of at least two points that lie on the actual tear line which is at the heart of the invention because the common factor is that both points are created by/resulting from the tearing of said tape and thus both points lie on the tape's actual tear line and therefore, when considered together, both points serve to guide a person to said tape's actual tear line. More specifically, a portion of the dotted line thus coincides exactly with a portion of the actual tear line as shown in FIG. 2. The following two approaches lead to both locating the tear and also ending up with said tape that is fully transparent or fully translucent as follows: 1. Said opaque portion of said tape can be can be made detachably connected via, for example, perforations located where the interior side of said opaque portion of said tape meets said partially either transparent or translucent portion of said tape so that following the actual tear being located/pinpointed when said opaque portion of said tape along with said opaque portion's “telltale” line is removed from said tape said tape will then become either fully transparent or fully translucent respectively. 2. By first starting with a roll of either fully transparent tape or fully translucent tape and subsequently attaching a removable strip of material that is designed to perform in the exact same way that the previously described said opaque portion of said tape performs such that after the tear is located and the removable strip of material is removed said tape will resume being either fully transparent or fully translucent.

Additionally and generally speaking, after a tear is located one of the most important factors is what best enables a person to separate the very end of said tape remaining on said roll of said tape from said roll of said tape and that involves determining the location where the most effective removal lift force can be applied to remove the very end of said tape remaining on said roll of said tape from said roll of said tape and that particular location is the exact prime location where either of the two outer side edges of said tape exist because those two locations are the only two locations where the most effective removal lift forces can occur in turn because those two locations are the only two locations where a force perpendicular to the surface of said tape can be fully applied and a force applied perpendicularly to anything is the maximum force that can be applied. Additionally, if a removal lift force is applied at any other location on said tape other than at either edge of said tape there would be resistive adhesive forces existing on both sides of the location where the removal lift force is applied versus when a removal lift force is applied on either side edge of said tape where the resistive adhesive force can only exist on one side of where the removal lift force is applied and thus the combination of the reduced resistive adhesive forces in addition to the afore mentioned perpendicular factor allow for an easier separation/removal of the very end of said tape remaining on said roll of said tape from said roll of said tape following the previous removal of a portion of said tape from said roll of said tape. Furthermore, either side edge of said tape is the only location where the full side thickness of the tape is presented to allow maximum rubbing friction to also be applied perpendicularly to the full side surface of said tape to best help to pry said tape still attached to/left on/remaining on said roll of tape away from said roll of said tape.

### DETAILED DESCRIPTION OF INVENTION

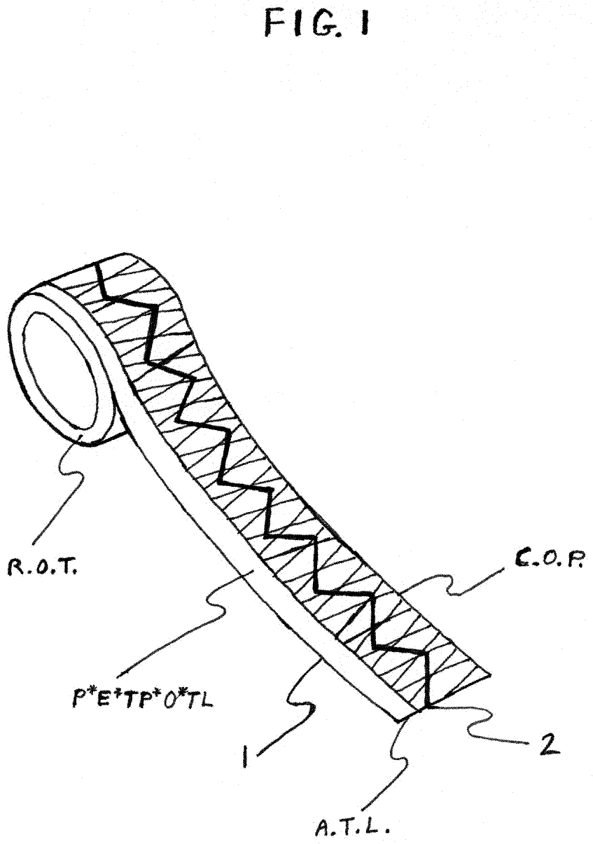

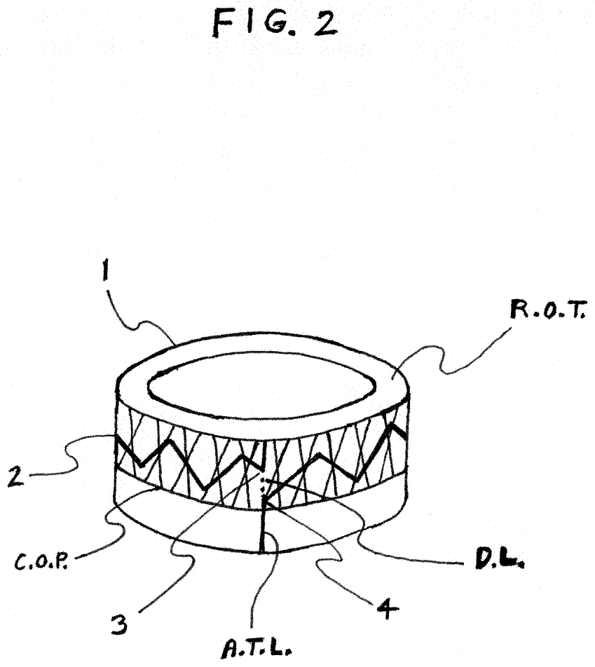

The utilitarian purpose of this invention is to help a person to more easily, efficiently and timely access the remaining end of an item such as tape (1) which is partially either transparent or translucent P*E*TP*O*TL on a roll of tape (R.O.T.) as shown in FIGS. 1 and 2. In order to achieve the stated purpose of this invention as well as to provide an understanding of how the invention works the following is provided: FIG. 1 shows a portion of said tape (1) which is partially unraveled from said roll of tape (R.O.T.) following the most recent removal of a portion of said tape (1) from said roll of tape (R.O.T.) as well as the fixed width crosshatched opaque portion (C.O.P.) of said tape (1) (shown as being crosshatched in this case because of the limitation of only the colors black and white being available) located at a fixed position within the confines of the side edges of said tape (1) and thus also being parallel to both of the side edges of said tape (1) in addition to the requirement of having one side of said fixed width crosshatched opaque portion (C.O.P.) of said tape (1) also being coincident with one of the side edges of said tape (1) with all of the fore going leading directly to what lies at the heart of the invention which is a marking on said fixed width crosshatched opaque portion (C.O.P.) of said tape (1) which in this case is shown as a solid black “telltale” line (2) and which, because the “telltale” line plays an essential major part in locating the tear is also shown graphically as being wider than all other lines in FIGS. 1 and 2, in order to both differentiate said “telltale” line (2) from all other lines in FIGS. 1 and 2 as well as from said fixed width crosshatched opaque portion (C.O.P.) of said tape (1). The exact manner in which said “telltale” line (2) locates the tear is as follows: said “telltale” line (2) is made to continuously vary in distance from either side edge of said fixed width crosshatched opaque portion (C.O.P.) of the tape (1) which has in turn resulted in the following: on said roll of tape (R.O.T.) shown in FIG. 2 there appears to be two end points (3) and (4) on two separate “telltale” lines, however, in actuality, there is only one “telltale” line (2) such that said tape (1) has only one actual end point (3) versus the virtual end point (4) because the virtual end point (4) only exists as an optical illusion having resulted from the actual end of said torn tape (1) covering another portion of the one and only “telltale” line (2) that exists on said tape (1) which is still attached to the roll of tape (R.O.T.) following the most recent removal of tape (1) from the roll of tape (R.O.T.). Because a dotted line shows different from all other lines in FIG. 2, FIG. 2 has employed the dotted line (D.L.) to connect both points (3) and (4), in order to help bring attention to the location of a portion of the actual tear which is at the heart of the invention because the common factor is that both points (3) and (4) are created by/resulting from the tearing of said tape (1) and thus both points (3) and (4) lie on the actual tear line (A.T.L.) of said tape (1) and thus when considered together, both points (3) and (4) serve to guide a person to the actual tear line (A.T.L.) of said tape (1). More specifically, a portion of the dotted line (D.L.) thus coincides exactly with a portion of the actual tear line (A.T.L.) of said tape (1) shown in FIG. 2. The following two approaches lead to both locating the tear as well as ending up with said tape (1) that is either fully transparent or fully translucent as follows:
1. Said crosshatched opaque portion (C.O.P.) of said tape (1) can be made detachably connected via, for example, perforations located where the interior side of crosshatched opaque portion (C.O.P.) of said tape (1) meets said P*E*TP*O*TL portion of said tape (1) so that following the actual tear line (A.T.L.) being located/pinpointed when said crosshatched opaque portion (C.O.P.) of said tape (1) along with said crosshatched opaque portion's (C.O.P.) “telltale line (2) is removed from said tape (1) said tape (1) will then become either fully transparent or fully translucent respectively.
2. By first starting with a roll of either fully transparent tape or fully translucent tape and subsequently attaching a removable strip of material that is designed to perform in the same exact way that the previously described said opaque portion of said tape performs such that after the tear is located and the removable strip of material is removed, said tape will resume being fully transparent or fully translucent.

Additionally and generally speaking, after a tear is located one of the most important factors is what best enables a person to separate the very end of said tape (1) remaining on said roll of tape (R.O.T.) and that involves determining the location of where the most effective removal lift force can be applied to remove the very end of said tape (1) that is remaining on said roll of tape (R.O.T.) and that particular location is the exact prime location where either of the two outer side edges of said tape (1) exist because those two locations are the only two locations where the most effective removal lift forces can occur in turn because those two locations are the only two locations where a force perpendicular to the surface of said tape (1) can be applied and a force applied perpendicularly to anything is the maximum force that can be applied. Additionally, if a removal lift force is applied at any other location on said tape (1) other than at the edge of said tape (1) there would be restrictive adhesive forces existing on both sides of the location where the removal lift force is applied helping to prevent the removal of said tape (1) from said roll of tape (R.O.T.) versus when a removal lift is applied on either side edge of said tape (1) where the resistive adhesive force can only exist on one side of where the removal lift force is applied and thus the combination of the reduced resistive adhesive forces in addition to the afore mentioned perpendicular factor allow for an easier separation/removal of the very end of said tape (1) remaining on said roll of tape (R.O.T.) from said roll of tape (R.O.T.) following the previous removal of a portion of said tape (1) from said roll of tape. Furthermore, either side edge of said tape (1) is the only location where the full side thickness of said tape (1) is presented to allow maximum rubbing friction to also be applied perpendicularly to the full side surface of said tape (1) to best help pry said tape (1) still attached to/left on/remaining on said roll of tape (R.O.T.) away from said roll of tape (R.O.T.).

What we claim our invention is:

1. A method comprising providing a rolled material comprising: a strip of rolled material that presents as partially either transparent or translucent having a certain fixed width and thickness as well as having both sides of an opaque portion of fixed width being located within the confines of the said certain fixed width of said rolled material that is partially either transparent or translucent as well as one side of said opaque portion of fixed width being coincident with one side edge of said rolled material that is partially either transparent or translucent separate from said opaque portion of fixed width being positioned along the full length of said rolled material that is partially either transparent or translucent: marking said opaque portion of fixed width of said rolled material that is partially either transparent or translucent with a continuous “telltale” marking such as a line of certain fixed width, said “telltale” line being positioned diagonally or otherwise in relation to each/either side edge of said opaque portion of fixed width of said rolled material that is partially either transparent or translucent and extending the full length of said opaque portion of fixed width of said rolled material that is partially either transparent or translucent so as to create a break in said “telltale” line on said opaque portion of fixed width of said rolled material that is partially either transparent or translucent when a portion of the strip of said rolled material that is partially either transparent or translucent is removed from the said roll of said rolled material that is partially either transparent or translucent, thus distinguishing/pinpointing the end position/location of said rolled material that is partially either transparent or translucent that is still attached to/left on/remaining on said roll of said rolled material that is partially either transparent or translucent. Additionally and generally speaking, after a tear is located one of the most important factors is what best enables a person to separate the very end of said rolled material remaining on said roll of rolled material from said roll of rolled material and that involves determining the location where the most effective removal lift force can be applied to remove the very end of said rolled material remaining on said roll of rolled material and that particular location is the exact prime location where either of the two side edges of said rolled material exist because those two locations are the only two locations where the most effective removal lift forces can occur in turn because those two locations are the only two locations where a force perpendicular to the surface of the rolled material can be fully applied because a force applied perpendicularly to anything is the maximum force that can be applied. Additionally, if a removal lift force is applied at any other location on said rolled material other than at either side edge of said rolled material there would be resistive adhesive forces existing on both sides of the location where the removal lift force is applied versus when a removal lift force is applied on either side edge of said rolled material where the resistive adhesive force can only exist on one side of where the removal lift force is applied and thus the combination of the reduced resistive forces in addition to the afore mentioned perpendicular factor allow for an easier separation/removal of the very end of said rolled material remaining on said roll of said rolled material following the previous removal of a portion of said rolled material from said roll of said rolled material. Furthermore, either side edge of said rolled material is the only location where the full side thickness of the rolled material is presented to allow maximum rubbing friction to also be applied perpendicularly to the full side surface of said rolled material to best help to pry said rolled material away from said rolled material still attached to/left on/remaining on said roll of said rolled material. Having established that the best first step in the process to remove the actual end of the rolled material that is left on the roll of rolled material from the roll of rolled material involves one of the two sides of the rolled material thus leading to the second step in said process which then involves choosing which side of the two sides is the best side of the two sides to begin removing the actual end of the rolled material that is left on the roll of rolled material from the roll of rolled material and that side is the side which is closest to where the actual beak and the illusionary break show/occur on the “telltale” line because, statistically, the closer that one item is located relative to a second item the higher the chance that the second item can be located.

2. The process of claim 1 wherein said opaque portion of fixed width of said rolled material that is partially either transparent or translucent is marked in such a way as to also delineate the starting point of said rolled material that is partially either transparent or translucent that is still attached to/left on/remaining on said roll of said rolled material that is partially either transparent or translucent following each and every removal of said rolled material that is partially either transparent or translucent from said roll of said rolled material that is partially either transparent or translucent.

3. The process of claim 2 wherein the marking comprises at least/at minimum a single “telltale” line of a contrasting color relative to the other color(s) that exist on the opaque portion of fixed width of said roll of said rolled material that is partially either transparent or translucent.

4. The process of claim 3 wherein said “telltale” line is positioned at continuously varying distances from each/either side edge of the opaque portion of fixed width of said rolled material that is partially either transparent or translucent in addition to/separate from being in the form of a “telltale” line which was previously stated as being positioned diagonally or otherwise in relation to each/either side edge of the width of the opaque portion of fixed width of said rolled material that is partially either transparent or translucent.

5. The process of claim 4 where in by continuously varying the positioning of the “telltale” line relative to the side edge of the width of the opaque portion of fixed width of said rolled material that is partially either transparent or translucent the following occurs after the actual tearing off of a portion of said rolled material that is partially either transparent or translucent from said roll of said rolled material that is partially either transparent or translucent as follows: first, the actual end point of the “telltale” line, by virtue of the afore mentioned actual tearing, coincides with the actual end point of the portion of said rolled material that is partially either transparent or translucent that is still attached to/left on/remaining on said roll of said rolled material that is partially either transparent or translucent and second, the actual end of said rolled material that is partially either transparent or translucent that is still attached to/left on/remaining on said roll of said rolled material that is partially either transparent or translucent covers another portion of the “telltale” line at another location along the length of the “telltale” line in turn causing the illusion of the appearance of a separate/second “telltale” line existing on said roll of said rolled material that is partially either transparent or translucent. It is because the illusionary separate/second “telltale” line has been created by the afore mentioned actual tearing off of said rolled material that is partially either transparent or translucent that the end of the illusionary separate/second “telltale” line also lies on the actual tear line. Therefore, if a line is drawn connecting the afore mentioned actual end point of said rolled material that is partially either transparent or translucent that is still attached to/left on/remaining on the roll of said rolled material that is partially either transparent or translucent to/with the afore mentioned illusionary end point of what seems to show as a separate/second “telltale” line, but is not, in actuality, a separate/second “telltale” line, that the afore mentioned connecting line will thus also coincide with a portion of the actual tear line. Because both the afore mentioned actual and illusionary end points by virtue of their very creation lie on the actual tear line the location of both the aforementioned actual and illusionary endpoints will also serve as a guide to the location of the end position/location of said rolled material that is partially either transparent or translucent that still attached to/left on/remaining on said roll of rolled material that is partially either transparent or translucent.

6. The process of claim 5 wherein said opaque portion of fixed width of said rolled material that is partially either transparent or translucent can be made detachably connected via, for example, perforations located where the interior side of said opaque portion of fixed width of said rolled material that is partially either transparent or translucent meets the portion of said rolled material that is partially either transparent or translucent so that following the actual tear being located/pinpointed when said opaque portion of fixed width of said rolled material that is partially either transparent or translucent is removed from said rolled material that is partially either transparent or translucent said rolled material that is partially either transparent or translucent will become either fully transparent or fully translucent.

7. The process of claim 6 wherein a strip of rolled material incorporating exactly the previously described said fixed width opaque strip of rolled material with said fixed width opaque strip's “telltale” line is detachably attached to a roll of rolled material that is either fully transparent or fully translucent so that after the tear line is located when said strip of rolled material incorporating exactly the previously described said fixed width opaque strip of rolled material with said fixed with opaque strip's “telltale” line is removed from said rolled material said rolled material will again become either fully transparent or fully translucent.
